(19) United States
(12) Patent Application Publication
(10) Pub. No.: US 2007/0250893 A1
(43) Pub. Date: Oct. 25, 2007

(54) DIGITAL BROADCASTING RECEIVING APPARATUS

(76) Inventors: Yasuhiro AKIYAMA, Oume (JP); Koichi Hamada, Yokohama (JP); Muneaki Yamaguchi, Inagi (JP); Takashi Maruyama, Ebina (JP); Kouji Kamogawa, Yokohama (JP); Masahiro Kageyama, Hino (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/620,820

(22) Filed: Jan. 8, 2007

(30) Foreign Application Priority Data
Apr. 3, 2006 (JP) 2006-101400

(51) Int. Cl. H04N 7/16; H04N 7/173; H04N 5/44

(52) U.S. Cl. 725/131; 725/100; 348/725; 348/731; 725/151

(57) ABSTRACT

Disclosed herein is a digital broadcasting receiving apparatus that can offer high-definition images with appropriate image quality correction by setting the quantity of image quality correction with reference to encoding information and image information in pixel blocks. The apparatus includes an image processing unit for performing image processing on decoded image signals. This image processing unit has a noise detection unit for detecting noise information for each pixel block based on encoding information of images included in digital broadcasting signals, a setting unit for setting the quantity of image quality correction based on noise information detected by the noise detection unit and image information for each pixel block of the decoded image signals, and a unit for performing image quality correction on each pixel block of the decoded image signals with the quantity of image quality correction set by the image quality setting unit.

### BACKGROUND OF THE INVENTION

(1) Field of the Invention

The present invention relates to an image quality correction technology for a digital broadcasting receiving apparatus capable of receiving digital broadcasting signals.

(2) Description of the Related Art

In digital broadcasting, image signals are encoded to digital signals by MPEG-4 (Moving Picture coding Experts Group Phase 4), H.264/AVC (Advanced Video Coding) or the like. Encoding conditions or states often causes block noise and mosquito noise in the reproduced images after decoding the digital signals. For example, in those cases where low encoding bit rates are set or images that include many fast-moving scenes of sport broadcasts are encoded, such noises as mentioned above are more likely to be generated. To reduce such noises as related to encoding, the well-known technology described in Japanese Patent Laid-Open Publication (JP-A) No. 2003-18600 discloses that the noises' generation is predicted based on quantization information at the time of image encoding, and according to this prediction, image quality corrections such as edge enhancement are performed on each block.

### SUMMARY OF THE INVENTION

In the past, image quality correction has been performed using only encoding information related to quantization parameters and the like without decoded image information taken into account. Therefore, it has been difficult to perform accurate image quality correction.

The present invention addresses the problems and aims to provide a technology that causes a digital broadcasting receiving apparatuses to perform more appropriate image quality correction thereby to obtain high-definition images.

According to one aspect of the present invention, image quality correction to image signals can be performed on each pixel block based on both encoding information included in digital broadcasting signals and image information obtained from decoded image signals, wherein the encoding information includes at least one of bit rate information, quantization step information, DCT coefficient information, and motion vector information related to the digital broadcasting signals. Image quality correction may be made by comparing each piece of encoding information for each block with the corresponding threshold so as to judge whether the block has such noise as block noise.

If it is judged that a pixel block includes block noise, image quality correction is performed on the block by setting the quantity of image quality correction (such as the quantity of edge enhancement or the quantity of noise reduction) using image information of the block, such as level differences among the luminance component values of neighboring pixels in the block.

The aspect of the present invention is configured as above and thus can perform accurate image quality correction. The quantity of the image quality correction may be changed according to categories of received digital broadcasting programs. The aspect of the present invention can be more suitably applied to apparatuses for receiving and displaying 1 segment broadcasting with lower bit rates that is broadcast to mobile terminals such as cellular phones.

As stated above, the aspect of the present invention can offer high definition images by performing more appropriate image quality correction.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a configuration example of a digital broadcasting receiving apparatus to which one embodiment of the present invention is applied;

FIG. 2 is a block diagram showing a configuration example of an image processor 100;

FIG. 3 is a flowchart showing entire image quality correction processing related to a first embodiment of the present invention;

FIG. 4 is a block diagram showing the illustrative embodiment of a noise detector unit 101;

FIG. 5 is a graph showing an example setting of a first threshold BRth;

FIG. 6 is a graph showing an example setting of a second threshold Qth;

FIG. 7 is an explanatory diagram showing a configuration example of DCT coefficients referred to at DCT coefficient judgment unit;

FIG. 8 is a graph showing an example setting of a third threshold Dth;

FIG. 9 is a graph showing an example setting of a fourth threshold MVth;

FIG. 10 is a flowchart showing noise judgment processing at the noise detection unit 101;

FIG. 11 is an explanatory diagram showing an example of the relation between block noise generation states and blocks targeted for image quality correction;

FIG. 12 is an explanatory diagram showing an example of the calculation method to determine the quantity of edge enhancement for each block at a setting unit 102;

FIG. 13 is a graph showing an example of the relation between pixel state coefficient X of a block and the quantity of edge enhancement;

FIG. 14 is a diagram showing an example of an edge enhancement table used at the setting unit 102;

FIG. 15 is a diagram showing an example of a memory used at the setting unit 102;

FIG. 16 is a flowchart showing processing to set the quantity of edge enhancement at the setting unit 102;

FIG. 17 is an explanatory diagram showing a second embodiment of the present invention; and

FIG. 18 is an explanatory diagram showing the second embodiment of the present invention.

### DETAILED DESCRIPTION OF THE PREFERRED EMBODIMENTS

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

The preferred embodiments of the present invention will be described in detail hereafter with reference to the attached drawings. Although the embodiments of the present invention can be widely applied to digital broadcasting receiving apparatuses, it is particularly preferable to apply the embodiments of the present invention to apparatuses for receiving terrestrial digital broadcasting toward mobile terminals such as cellular phones (1 segment broadcasting. 1-seg broadcasting for short hereafter). This is because in many cases 1-seg broadcasting sends images after encoding the images at low bit rate such as several hundreds kbps to several Mbps due to limits to the frequency bandwidth of transmitting systems and limits to the processing capacities of mobile terminals and the like. Therefore, apparatuses for receiving and displaying 1-seg broadcasting are under the condition that noises related to encoding conditions and states, that is, block noise and mosquito noise are easily generated, and also due to low bit rate, reproduced images are poor in quality, especially lacking in sharpness. In such apparatuses, the embodiments of the present invention can perform good image quality correction, especially edge enhancement while reducing noises or keeping noises from being emphasized.

### First Embodiment

Firstly, a first embodiment of the present invention will be described below.

### Description of the Whole Configuration

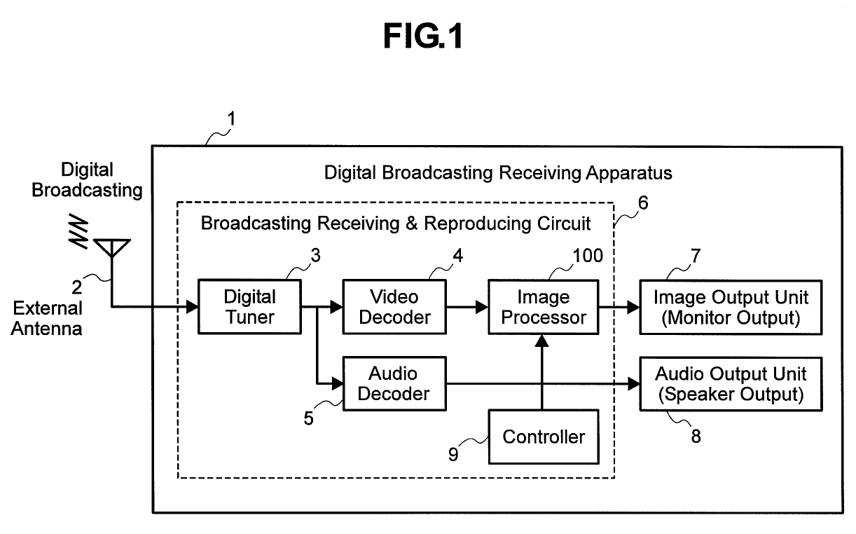

A configuration example of a digital broadcasting receiving apparatus, to which the present invention can be applied, will be described hereafter with reference to FIG. 1. In FIG. 1, a digital broadcasting apparatus 1 can be, for example, portable or mobile digital broadcasting receiving apparatus such as a cellular phone, a note personal computer (a note PC), a car navigation system or the like. However, the digital broadcasting apparatus 1 can also be applied to stationary television display apparatuses such as a PDP-TV set, a LCD-TV set. The digital broadcasting apparatus 1 can also be applied to a DVD player and a HDD player. The digital broadcasting apparatus 1 according to this embodiment of the present invention includes, for example, an external antenna 2 for receiving digital broadcasting signals such as 1-seg broadcasting signals, a broadcasting receiving & reproducing circuit 6 for reproducing the received digital broadcasting signals, an image output unit 7 for displaying the image signals that are output from the broadcasting receiving & reproducing circuit 6, and a audio output unit 8 for outputting sounds based on the audio signals that are output from the broadcasting receiving & reproducing circuit 6. This embodiment can be applied not only to, for example, a note PC that mounts a receiving & reproducing circuit of 1-seg broadcasting signals as one of standard functions, but also to a general note PC that is equipped with the broadcasting receiving & reproducing circuit 6 as an extended circuit (hardware).

The broadcasting receiving & reproducing circuit 6 is connected to the external antenna 2, and includes a digital tuner 3 for receiving digital broadcasting signals; a video decoding unit 4 for decoding encoded video signals (video signals encoded by means of H.264, for example) out of the received signals received by the digital tuner 3; an audio decoding unit 5 for decoding encoded audio signals (audio signals encoded by means of AAC, for example); and an image processor 100 for performing image quality correction on the video images decoded by the video decoding unit 4. A controller 9 includes, for example, a CPU and sends various control signals related to image quality correction to the image processor 100. And then the image data on which image quality correction has been performed at the image processor 100 is provided to the image output unit 7 for the image to be displayed. The audio data decoded at the audio decoding unit 5 is sent to an audio output unit 8 for the sound of the audio data decoded to be output.

This embodiment is characterized in that image quality correction is performed on an image data using encoding information of an image included in digital broadcasting signals and image information obtained from decoded image data.

### Description of the Image Processor 100

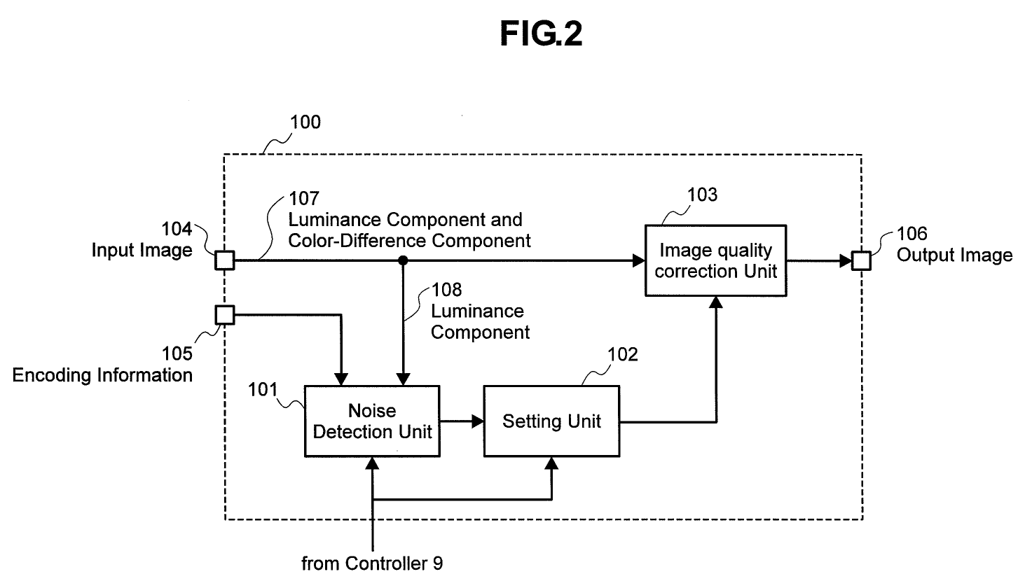

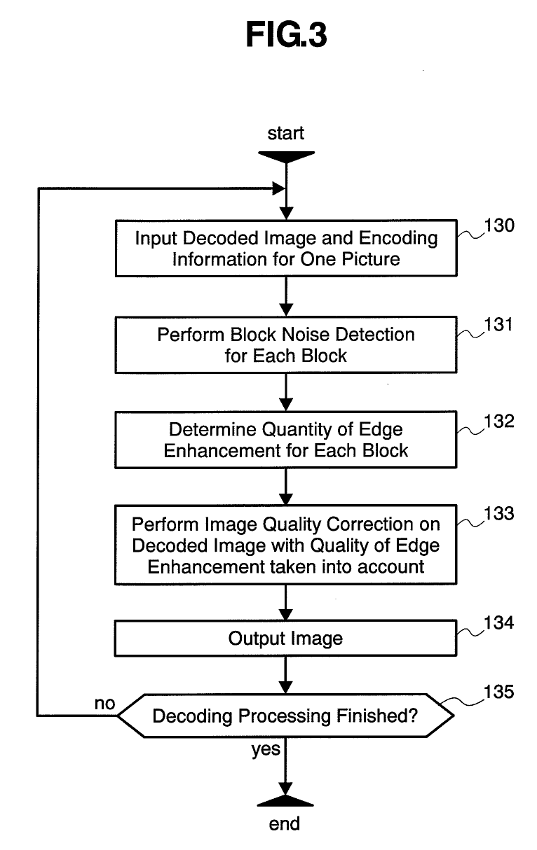

The image processor 100 related to this embodiment will be described in detail with reference to FIG. 2 and FIG. 3. FIG. 2 shows a configuration example of the image processor 100 related to this embodiment.

The image processor 100 includes an image input terminal 104 for obtaining an image data from the video decoder unit 4 and an information input terminal 105 for obtaining encoding information. An image data 107 that is input through the image input terminal 104, which includes luminance component data and color-difference component data, is sent to an image quality correction unit 103. Luminance component data 108 of the image data 107 is also sent to a noise detection unit 101. On the other hand, an encoding information data that is input through the information input terminal 105 is also sent to the noise detection unit 101. Encoding information, which is stored in the header of bit streams in digital broadcasting signals, is separated when the coded image is decoded at the video decoding unit 4, and is sent to the information input terminal 105. In this embodiment, encoding information includes bit rate information, quantization step information, DCT coefficient (corresponding to AC component) information, and motion vector information, but any other information can be included in encoding information if necessary.

The noise detection unit 101 detects the locations of noises that appear in images using encoding information that is input through the information input terminal 105 and control signals from the controller 9. In this embodiment, assuming that noise is block noise, block noise generation locations are detected. More specifically, the noise detection unit 101 related to this embodiment specifies which pixel blocks (blocks for short hereafter) include block noise using encoding information such as video bit rate information, quantization step information, DCT coefficient information, motion vector information, and control signals from the controller 9. The locations of block noises detected by the noise detection unit 101 are sent to a setting unit 102 as block noise information. Referring to image information for each block sent from the controller 9, the setting unit 102 sets the quantity of image quality correction for each block of the image. In this embodiment, it is assumed that the quantity of edge enhancement that enhances the edges of an image is set as the quantity of image quality correction. Here the setting unit 102 related to this embodiment changes or modifies the quantity of edge enhancement, which has been set as mentioned above, according to the results detected at the noise detection unit 101. More specifically, when there is no block noise, the quantity of edge enhancement is set maximum and when there is block noise, the quantity of edge enhancement is changed or modified to be lower than maximum so as not to enhance the noise. For example, edge enhancement is not performed on blocks with block noise (i.e., the quantities of edge enhancement are zero) or edge enhancement is performed on blocks with block noise using smaller quantities of edge enhancement than the quantities of edge enhancement for blocks without noise. On the other hand, the quantities of edge enhancement for blocks without noise are set large because there is no noise to be enhanced by large quantities of edge enhancement. The image quality correction unit 103 performs image quality correction including edge enhancement on the image data 107 with the qualities of edge enhancement set at the setting unit 102. Although in the above description it has been described that edge enhancement processing is performed as image quality correction at the image quality correction unit 103, noise canceling processing to reduce noises can be performed instead of edge enhancement processing. For example, noise canceling processing is performed on blocks with block noise. In this case, noise canceling processing can be performed on blocks with block noise using larger quantities of noise canceling than the quantities of noise canceling for blocks without block noise. On the other hand, noise canceling processing is not performed at all on blocks without block noise or noise canceling processing is performed using smaller quantities of noise canceling than the quantities of noise canceling for blocks with block noise. The image data, on which image quality correction is performed in this way at the image quality correction unit 103, is provided to the image output unit 7 through an output image terminal 106.

The whole flow of image quality correction processing at the image processor 100 that is configured in this way will be described with reference to FIG. 3. Firstly, at Step 130, a decoded image data for 1 picture is input to the image input terminal 104, while encoding information corresponding to the decoded image data is input to the information input terminal 105. Secondly, at step 131, each block noise for every block that constitutes the image is detected at the noise detection unit 101 using the encoding information and control signals from the controller 9. Thirdly, at Step 132, the quantity of edge enhancement for each block is determined at the setting unit 102 using the image information for each block sent from the controller 9 with reference to the noise detection results from the noise detection unit 101. Then, at Step 133, image quality correction (edge enhancement processing) is performed on the image data 107 for each block at the image quality correction unit 103 using the quantity of edge enhancement determined at the setting unit 102. The image data, on which image quality correction is performed, is output through the image output terminal 106, and is provided to the image output unit 7 at Step 134. These successive processes are repeated until decoding processing is finished. In other words, the judgment whether decoding processing is finished or not is made at Step 135. If decoding processing is not finished, the procedure return to Step 130. If decoding processing is finished, these successive processes stop.

The functions of the image processor 100 related to this embodiment are not limited by the size of an image size. Therefore these functions of the image processor 100 can be applied to various image display systems. For example, the size of an image of 1-seg broadcasting toward mobile terminals such as cellular phones is the size of QVGA (Quarter Video Graphics Array with 320×240 pixels). The image processor 100 receives a QVGA image from outside and performs image quality correction processing on the QVGA image, and then the image processor 100 outputs the corrected QVGA image. Generally speaking, a QVGA image often gives the impression that the display size of its image is small. Therefore, scaling processing to scale up the QVGA image to a VGA (Video Graphics Array with 640×480 pixels) image can be performed on the QVGA image in parallel with image quality correction processing at the image processor 100 in order to improve the viewability of the displayed QVGA image. The size after scaling processing can be optionally selectable. In the case of a digital TV set such as a PDP-TV set, a LCD-TV set or the like, the size of a processed image can be converted to the size of Hi-Vision TV (with 1920×1088 pixels). As mentioned above, at the image processor 100 related to this embodiment, the size of an input image and the size of an output image can be set optional according to the system to which this embodiment is applied.

### Description of the Noise Detection Unit 101

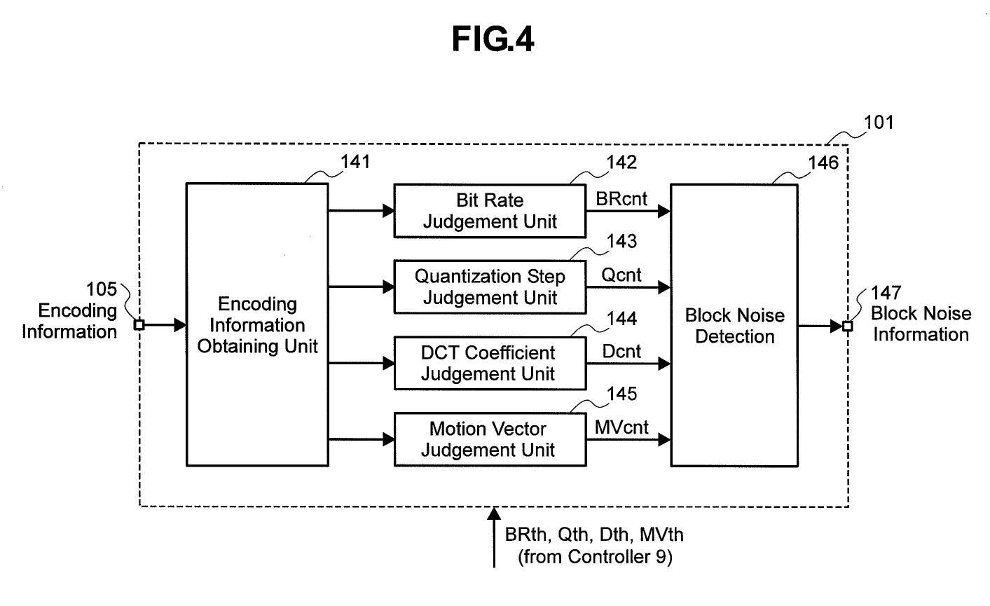

Next, each unit of the image processor 100 will be described in detail. Firstly, a noise detection unit 101 will be described in detail with reference to FIG. 4 to FIG. 11.

FIG. 4 shows a configuration example of the noise detection unit 101. The noise detection unit 101 includes an encoding information acquisition unit 141 to obtain encoding information necessary to perform block noise detection on an image that is input through the information input terminal 105. As mentioned above, encoding information includes bit rate information, quantization step information, DCT coefficient (corresponding to AC component) information, and motion vector information. The encoding information acquisition unit 141 obtains these pieces of information and delivers these pieces of information to four judgment units. More specifically, the encoding information acquisition unit 141 provides a bit rate judgment unit 142 with bit rate information, a quantization step judgment unit 143 with quantization step information, a DCT coefficient judgment unit 144 with DCT coefficient information, and a motion vector judgment unit 145 with motion vector information.

The bit rate judgment unit 142 compares the bit rate information for a block with a first threshold, that is, bit rate threshold BRth sent from the controller 9, and judges the condition of the block noise for the block. More specifically, when the value of the bit rate obtained from the bit rate information is equal to or lower than the first threshold BRth, the judgment that there is block noise is made and a control signal BRcnt to start up block a noise detection unit 146 is set ON (to enable the block noise detection unit 146). On the other hand, when the value of the bit rate is higher than the first threshold BRth, the judgment that there is no block noise is made and the control signal BRcnt is set OFF (to disable the block noise detection unit 146). The control signal BRcnt set in this way is sent to the block noise detection unit 146.

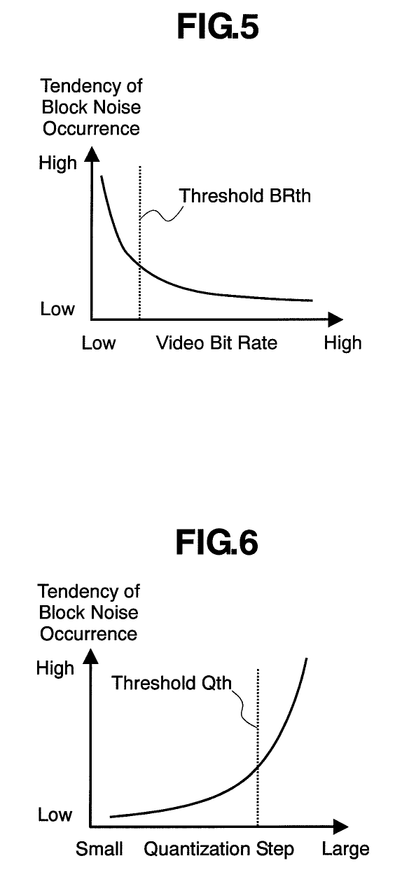

Here how to set the first threshold, that is, the bit rate threshold BRth, will be described. An image with a higher bit rate has higher quality, and an image with a lower bit rate more often loses its original image information, resulting in the degradation of the image quality and frequent block noise occurrence. FIG. 5 shows the relation between video bit rate and tendency of block noise occurrence. In FIG. 5, the horizontal axis shows video bit rate and vertical axis shows tendency of block noise occurrence.

As is clear from FIG. 5, the lower the value of bit rate is, the higher the tendency of block noise occurrence is. Based on this relationship and empirical values gotten from experiments etc. by inventors of the present invention and others, a threshold where block noise begins to be noticed with high possibility is set as the video bit rate threshold BRth.

The video bit rate threshold BRth can be changed according to the types (genres) of digital broadcasting programs that are input to the digital broadcasting receiving apparatus 1. Here the types of digital broadcasting programs mean the categories of image contents of, for example, drams, sports, news, movies. For example, assuming that a threshold for dramas is the reference video bit rate threshold BRth, a threshold for sports programs with fast-moving scenes can be set lower than the threshold BRth and a threshold for news with comparatively slow-moving scenes can be set higher than the threshold BRth. A threshold for movies can be equal to or a little lower than the threshold BRth.

The quantization step judgment unit 143 compares the quantization step information for a block with a second threshold, that is, quantization step threshold Qth sent from the controller 9, and judges the condition of the block noise for the block. More specifically, when the value of the quantization step obtained from the quantization step information is equal to or larger than the second threshold Qth, the judgment that there is block noise is made and a control signal Qcnt to start up the block noise detection unit 146 is set ON (to enable the block noise detection unit 146). On the other hand, when the value of the quantization step is smaller than the second threshold Qth, the judgment that there is no block noise is made and a control signal Qcnt is set OFF (to disable the block noise detection unit 146). The control signal Qcnt set in this way is sent to the block noise detection unit 146.

Here how to set the second threshold, that is, the quantization step threshold Qth, will be described. When an image is encoded, quantization step is used to quantize the image data for a block that has been transformed by two-dimensional DCT. If the value of quantization step is set larger, compression ratio becomes larger, and higher encoding efficiency can be achieved. However, if the value of quantization step is set larger, the encoded image data more often loses its original image information, resulting in the degradation of its image quality and frequent block noise occurrence. FIG. 6 shows the relation between quantization step and tendency of block noise occurrence. In FIG. 6, the horizontal axis shows quantization step and vertical axis shows tendency of block noise occurrence.

As is clear from FIG. 6, the larger the value of quantization step is, the higher the tendency of block noise occurrence is. Based on this relationship and empirical values gotten from experiments etc. by inventors of the present invention and others, a threshold where block noise begins to be noticed with high possibility is set as the quantization step threshold Qth. The quantization step threshold Qth can also be changed according to the categories of programs. For example, assuming that a threshold for dramas is the reference quantization step threshold Qth, a threshold for sports programs can be set larger than the threshold Qth and a threshold for news can be set smaller than the threshold Qth. A threshold for movies can be equal to or a little larger than the threshold Qth.

The DCT coefficient judgment unit 144 compares the DCT coefficient information for a block with the third threshold, that is, DCT coefficient threshold Dth sent from the controller 9, and judges the condition of the block noise for the block. More specifically, when the number of zeroes in the two-dimensional DCT coefficients (corresponding to AC components) obtained from the DCT coefficient information is equal to or larger than the third threshold Dth, the judgment that there is block noise is made and a control signal Dcnt to start up the block noise detection unit 146 is set ON (to enable the block noise detection unit 146). On the other hand, when the number of zeroes in the two-dimensional DCT coefficients (corresponding to AC components) is smaller than the third threshold Dth, the judgment that there is no block noise is made and a control signal Dcnt is set OFF (to disable the block noise detection unit 146). The control signal Dcnt set in this way is sent to the block noise detection unit 146.

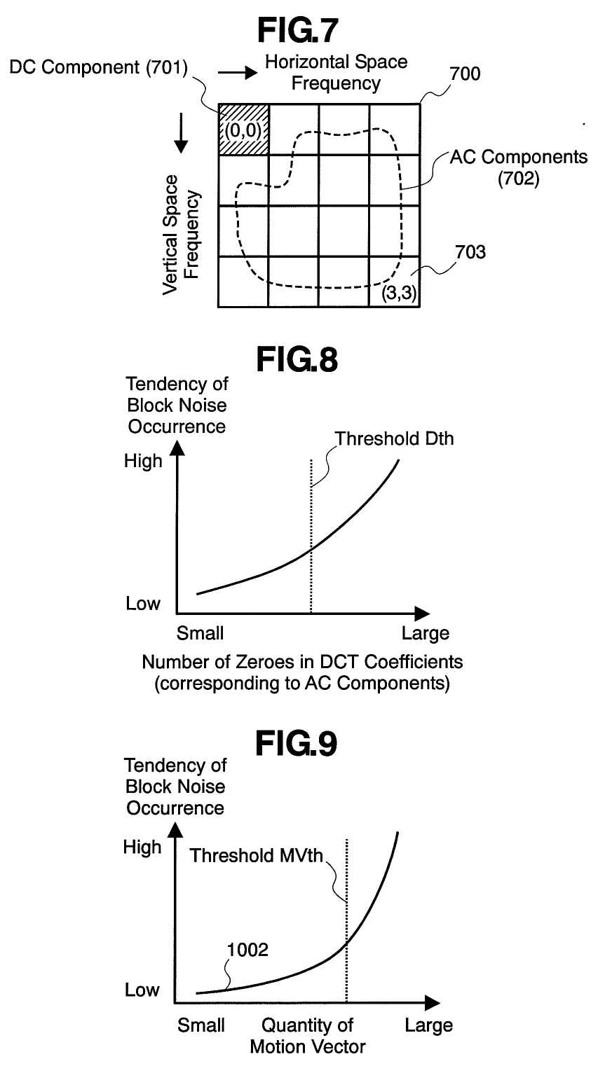

FIG. 7 is an explanatory diagram showing a configuration example of the DCT coefficients referred to at the DCT coefficient judgment unit 144. A two-dimensional DCT coefficients 700 consists of DC component (direct current) that shows the image component with the lowest spatial frequency (a first low frequency term) and plural AC components that show the image components with higher spatial frequencies (higher frequency terms) in a block. An example of FIG. 7 shows the smallest block configuration with 4×4 pixels of the configurations used in encoding processing based on International Standard of Encoding Method H.264. In FIG. 7, the horizontal axis shows DCT coefficient of horizontal spatial frequency and the vertical axis shows DCT coefficient of vertical spatial frequency. The coordinate (0, 0) shows DC component 701 that is the image component with the lowest spatial frequency (the first low frequency term). And other coordinates show AC components 702 that are the image components with higher spatial frequencies (higher frequency terms). The coordinate (3, 3) shows AC component 703 with the highest spatial frequency.

Here how to set the third threshold, that is, DCT coefficient threshold Dth, will be described. As mentioned above, the two-dimensional DCT coefficients consist of DC component that shows the image component with the lowest spatial frequency (the first low frequency term) and plural AC components that show the image components with higher spatial frequencies (higher frequency terms) in a block. Among these coefficients, it is AC components that are referred to at the DCT coefficient judgment unit 144. High frequency terms in the DCT coefficients can be intentionally dropped (AC components can be set zero) by setting the value of quantization step large with the result that the encoding efficiency is improved. However lack of high frequency terms reduces fineness and sharpness of an image, resulting in frequent block noise occurrence. FIG. 8 shows the relation between the number of zeroes in DCT coefficients (corresponding to AC components) and tendency of block noise occurrence. In FIG. 8, the horizontal axis shows the number of zeroes in DCT coefficients corresponding to AC components and vertical axis shows tendency of block noise occurrence.

As is clear from FIG. 8, the larger the number of zeroes in DCT coefficients corresponding to AC components, the higher the tendency of block noise occurrence is. Based on this relationship and empirical values gotten from experiments etc. by inventors of the present invention and others, a threshold where block noise begins to be noticed with high possibility is set as the DCT coefficient threshold Dth. The DCT coefficient threshold Dth can also be changed according to the categories of programs. For example, assuming that a threshold for dramas is the reference DCT coefficient threshold Dth, a threshold for sports programs can be set larger than the threshold Dth and a threshold for news can be set smaller than the threshold Dth. A threshold for movies can be equal to or a little larger than the threshold Dth.

The motion vector judgment unit 145 compares the motion vector information for a block with a fourth threshold, that is, motion vector threshold MVth sent from the controller 9, and judges the condition of the block noise for the block. More specifically, when the value of motion vector obtained from the motion vector information is equal to or larger than the fourth threshold MVth, the judgment that there is block noise is made and a control signal MVcnt to start up the block noise detection unit 146 is set ON (to enable the block noise detection unit 146). On the other hand, when the value of motion vector is smaller than the fourth threshold MVth, the judgment that there is no block noise is made and a control signal MVcnt is set OFF (to disable the block noise detection unit 146). The control signal MVcnt set in this way is sent to the block noise detection unit 146.

Here how to set the fourth threshold, that is, the motion vector threshold MVth, will be described. A motion vector is one of the parameters that utilizes the fact that there is a high correlation between two successive images, and the motion vector is information that shows the relative position between an encoding target block and a reference block. A quantity of motion vector is a value that shows the distance between the coordinate positions of two blocks, and more specifically it is indicated in the number of pixels. The larger the motion of an image becomes, the more the number of encoding target blocks increases and also the larger the quantity of motion vector for each block becomes, resulting in the increase of the amount of code generation. However, in general, the limitations of system resources and the like impose restrictions on the maximum amount of code generation. The restrictions on the amount of code generation result in frequent block noise occurrence. FIG. 9 shows the relation between motion vector and tendency of block noise occurrence. In FIG. 9, the horizontal axis shows the quantity of motion vector and vertical axis shows tendency of block noise occurrence.

As is clear from FIG. 9, the larger the magnitude of a motion vector is, the higher the tendency of block noise occurrence is. Based on this relationship and empirical values gotten from experiments etc. by inventors of the present invention and others, a threshold where block noise begins to be noticed with high possibility is set as the motion vector threshold MVth. The motion vector threshold MVth can also be changed according to the categories of programs. For example, assuming that a threshold for dramas is the reference motion vector threshold MVth, a threshold for sports programs can be set larger than the threshold MVth and a threshold for news can be set smaller than the threshold MVth. A threshold for movies can be equal to or a little smaller than the threshold MVth.

As mentioned above, each judgment unit of 142 to 145 obtains the corresponding encoding information, compares it with the corresponding threshold and makes the judgment whether a reference block has block noise or not. Then each judgment unit sends its judgment result to the block noise detection unit 146 after setting corresponding control signal BRcnt, Qcnt, Dcnt or MVcnt ON or OFF.

The block noise detection unit 146 makes the judgment whether the reference block has block noise or not using these control signals BRcnt, Qcnt, Dcnt, and MVcnt. In other words, the block noise detection unit 146 specifies blocks where block noise exists using the thresholds. For example, the block noise detection unit 146 makes the judgment that a block has block noise if any one of control signals BRcnt, Qcnt, Dcnt, or MVcnt is ON. If all the control signals are OFF, the judgment that there is no block noise in the block is made. In this way the block noise detection unit 146 determines whether there is block noise or not for each block and sends the result to the setting unit 102 through an output terminal 147.

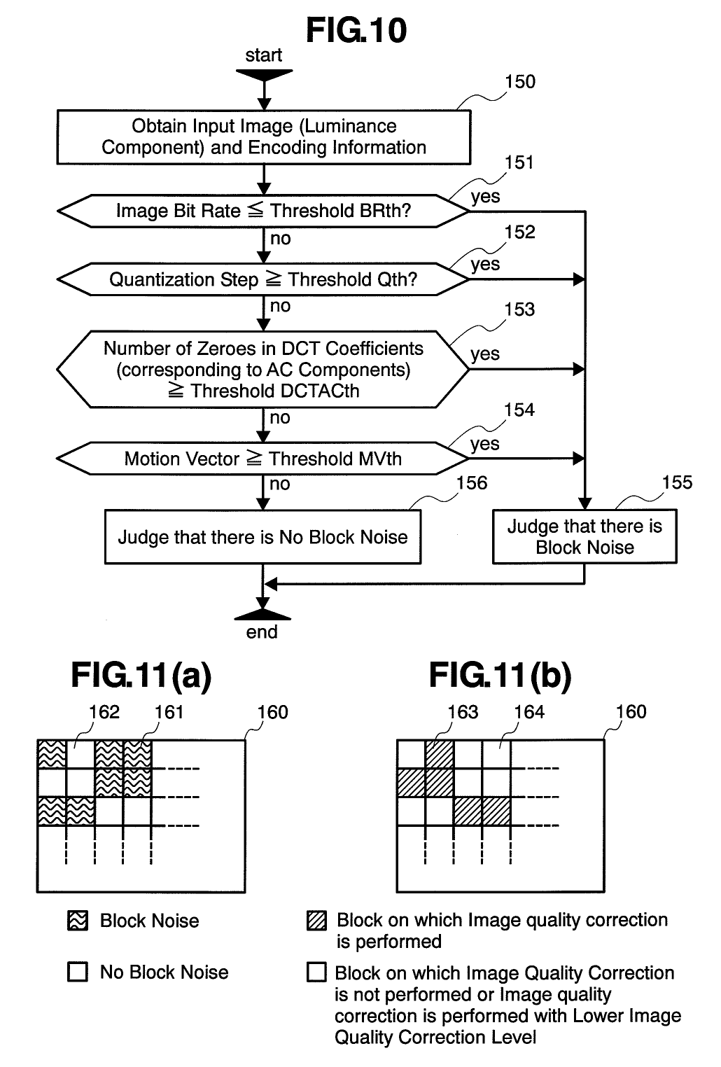

FIG. 10 shows the flow of the above-described processes to determine whether there is block noise or not for each block at the noise detection unit 101. The flowchart of FIG. 10 shows details of Step 131 of FIG. 3 that was previously described.

Firstly, at Step 150, the noise detection unit 101 obtains the luminance components of decoded image data and encoding information of the image data. Here as mentioned above, encoding information 105 includes video bit rate information, quantization step information, DCT coefficient (corresponding to AC component) information, and motion vector information. Secondly, at Step 151, the bit rate judgment unit 142 compares bit rate information with the first threshold BRth. When bit rate information is equal to or lower than BRth (in the case of yes), the control signal BRcnt is set ON and the flow proceeds to Step 155.

At above-mentioned Step 151, if the result of the judgment is “no”, the control signal BRcnt is set OFF and the flow proceeds to Step 152. Thirdly, at Step 152, the quantization step judgment unit 143 compares quantization step information with the second threshold Qth. When quantization step information is equal to or larger than Qth (in the case of yes), the control signal Qcnt is set ON and the flow proceeds to Step 155.

At above-mentioned Step 152, if the result of the judgment is “no”, the control signal Qcnt is set OFF and the flow proceeds to Step 153. Then, at Step 153, the DCT coefficient judgment unit 144 compares DCT coefficient information (the number of zeroes in DCT coefficients corresponding to AC components) with the third threshold Dth. When DCT coefficient information is equal to or larger than Dth (in the case of yes), the control signal Dcnt is set ON and the flow proceeds to Step 155.

At above-mentioned Step 153, if the result of the judgment is “no”, the control signal Dcnt is set OFF and the flow proceeds to Step 154. Lastly, at Step 154, the motion vector coefficient judgment unit 145 compares motion vector information with the fourth threshold MVth. When motion vector information is equal to or larger than MVth (in the case of yes), the control signal MVcnt is set ON and the flow proceeds to Step 155. On the other hand, at Step 15, if the result of the judgment is “no”, the control signal MVcnt is set OFF and the flow proceeds to Step 156.

Step 155 and Step 156 are operations at the block noise detection unit 146. More specifically, if anyone of the judgment results at Step 151 to 154 is “yes”, that is, if any one of control signals BRcnt, Qcnt, Dcnt, or MVcnt is “ON”, the judgment that the block has block noise is made at step 155, and the flow ends. On the other hand, if all the judgment results at Step 151 to 154 is “no”, that is, if all the control signals BRcnt, Qcnt, Dcnt, and MVcnt are “OFF”, the judgment that the block has no block noise is made at step 156, and the flow ends.

In the operation flow, although the judgment that a block has block noise is made if any one of the judgment results at Step 151 to 154 is “yes”, how to make the judgment is not limited to the way. For example, the judgment that a block has block noise can be made if any or predetermined two or three of the four control signals are “ON”.

This embodiment specifies which blocks include block noise in this way. And edge enhancement is not performed for blocks with block noise while edge enhancement is performed on blocks without block noise. In other words, in this embodiment, blocks without block noise are blocks targeted for image quality correction. FIG. 11 shows an example of the relation between a block noise generation state and blocks targeted for image quality correction in an input image.

FIG. 11a is an explanatory diagram showing an example of a block noise generation state of an input image 160. In the input image 160, let's suppose that blocks filled with wave lines (161 and the like) show blocks with block noise, and blocks with blank (162 and the like) show blocks without block noise. FIG. 11b shows an example of blocks targeted for image quality correction in the input image 160. Blocks filled with hatched lines (163 and the like) are blocks on which image quality correction is performed, and blocks with blank (164 and the like) are blocks on which image quality correction is not performed or image quality correction is performed with lower correction levels. In other words, image quality correction, that is, edge enhancement processing in this embodiment is not performed on blocks that are judged to have block noise. On the other hand, edge enhancement processing is performed on blocks that are judged to have no block noise because there is no noise to be enhanced by edge enhancement processing. Edge enhancement processing can be performed on blocks with block noise using smaller quantities of edge enhancement than the quantities of edge enhancement for blocks without block noise.

### Description of the Setting Unit 102

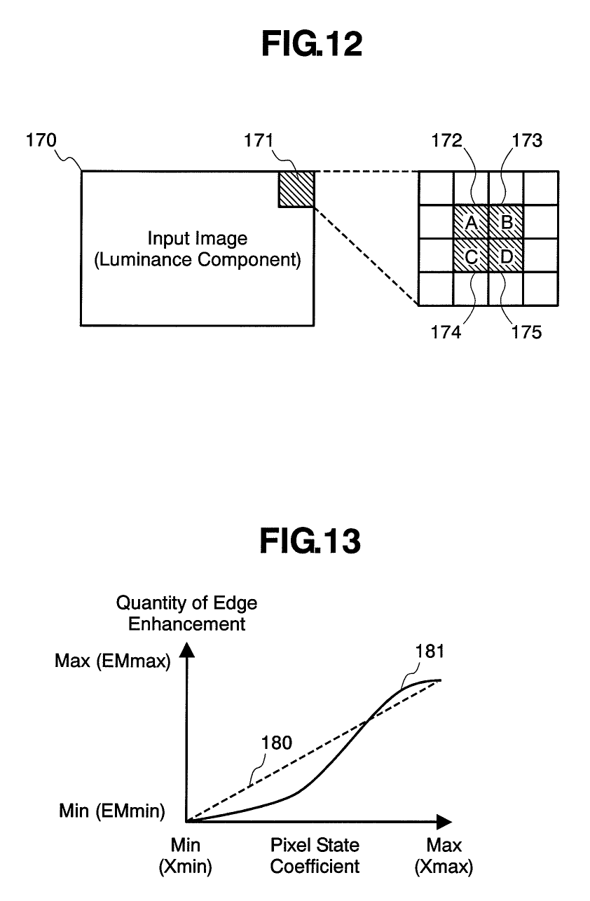

The setting unit 102 will be described in detail with reference to FIG. 12 to FIG. 16. The setting unit 102 sets the quantity of edge enhancement for a block that is judged to have no block noise by the noise detection unit 101 with reference to the pixel information of the block. FIG. 12 shows an example of the calculation method to determine an edge enhancement level for a block that is judged to have no block noise. In other words, the following processing is performed only on blocks that are judged to have no block noise.

The term “block” here is the unit of the pixel size that is a target for motion compensation processing at image encoding. Motion compensation processing is a technique that effectively encodes image data using the results of the examination of changes between two images that exist in two frames. A pixel size is the number of pixels that constitute a block. A pixel size is usually indicated by M×N, that is, the block is made up with the pixels arranged in a rectangle. For example, the pixel size of a block used in MPEG-1 or MPEG-2 is fixed at 16×16 pixels. In MPEG-4, both a block with 16×16 pixels and a block with 8×8 pixels can be used. And in H.264, a block with 16×16 pixels, a block with 16×8 pixels, a block with 8×16 pixels, and a block with 8×8 pixels can be used. A block with 8×8 pixels can be specified that it be divided into 4 types of subblocks with 8×8 pixels, 8×4 pixels, 4×8 pixels, or 4×4 pixels. In FIG. 12, the description will be made under the assumption that the pixel size of the reference block is 4×4 pixels. However, it goes without saying that the following processing can be applied to blocks with other pixel size.

In this embodiment, when image quality correction is performed on a block 171 in an input image (luminance component) 170 (under the assumption that the pixel size of the block 171 is 4×4 pixels), it is checked whether a pixel 172 to a pixel 175 other than outer circumferential pixels in the block 171 include high frequency components or not. Hereafter a parameter to indicate whether high frequency components are included or not shall be called pixel state coefficient X. Pixel state coefficient X is derived from the calculation that refers to the values of at least two pixels. In the example of FIG. 12, pixel state coefficient X is derived from the calculation that uses 4 pixels, that is, pixel A 172, pixel B 173, pixel C 174, and pixel D 172 that are located in the area of 2×2 pixels at the center of the block 171. Edge enhancement processing along the horizontal direction of an image and edge enhancement processing along the vertical direction of the image are performed independently in order to distinguish the frequency characteristics along the lateral (horizontal) direction of the image and the frequency characteristics along the longitudinal (vertical) direction of the image. At edge enhancement processing along the horizontal direction of an image, the arithmetic equation to give pixel state coefficient Xh is Eq. 1.

Xh=|A−B|+″C−D| (Eq. 1)

### On the other hand, at edge enhancement processing along the vertical direction of an image, the arithmetic equation to give pixel state coefficient Xv is Eq. 2.

Xh=|A−C|+|B−D| (Eq. 2)

Here A, B, C, and D in Eq. 1 and Eq. 2 are luminance signal levels, or high frequency component levels in luminance signals at pixel A 172, pixel B 173, pixel C 174, and pixel D 175 respectively.

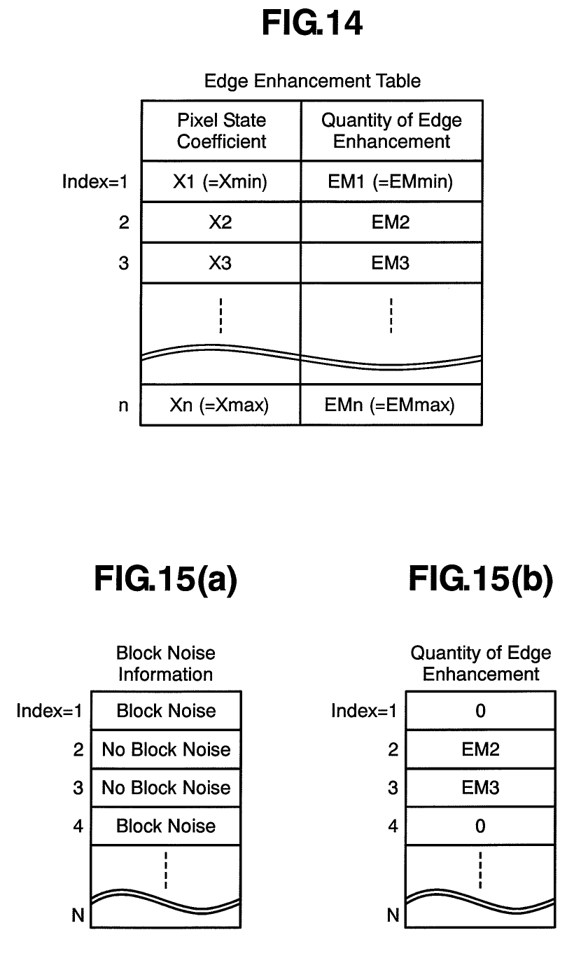

The calculation of pixel state coefficient along the horizontal direction Xh and pixel state coefficient along the vertical direction Xv are performed, for example, at the controller 9 in FIG. 1, and the coefficients Xh and Xv obtained from the calculation are provided to the setting unit 102. The setting unit 102 sets an actual quantity of edge enhancement with reference to the coefficients Xh and Xv provided by the controller 9. How to set the quantity of edge enhancement will be described in detail with reference to FIG. 13 and FIG. 14.

FIG. 13 is an example of the relation between pixel state coefficient X of a block and the quantity of edge enhancement, where X represents either pixel state coefficient along the horizontal direction Xh or pixel state coefficient along the vertical direction Xv (,that is, X=Xh or Xv). In FIG. 13, the horizontal axis shows the value of pixel state coefficient X and vertical axis shows the quantity of edge enhancement. Because there is not a big difference between the luminance component values of neighboring pixels when the above-mentioned pixel state coefficient X is small, the increase of the quantity of edge enhancement has a tendency not to be very effective. (The luminance component value of a pixel is abbreviated to a pixel value hereafter.) On the other hand, when the pixel state coefficient X is large, there is a big difference between the pixel values of neighboring pixels. Therefore, the increase of the quantity of edge enhancement has a tendency to be very effective. Judging from the relation, the quantity of edge enhancement for a block is set large when the pixel state coefficient X is large, and the quantity of edge enhancement for a block is set small when the pixel state coefficient X is small. Here the characteristics of the quantity of edge enhancement against pixel state coefficient X can be either linear as shown by the dashed line 180 or nonlinear as shown by the solid line 181 in FIG. 13. In other words, the setting unit 102 related to this embodiment is equipped with two characteristics of the quantity of edge enhancement shown by the dashed line 180 and the solid line 181, and sets the quantity of edge enhancement according to the pixel state coefficient X given by the controller 9 with reference to a linear or nonlinear characteristic curve shown by the dashed line 180 or the solid line 181 respectively.

In order to implement the characteristics shown by the dashed line 180 or the solid line 181 in FIG. 13, this embodiment uses, for example, an edge enhancement table as shown by FIG. 14. In other words, the setting unit 102 related to this embodiment maintains such an edge enhancement table, and obtains an actual quantity of edge enhancement corresponding to pixel state coefficient X from the table. In FIG. 14, the column “pixel state coefficient X” includes all the coefficient values from Xmin to Xmax that are supposed to appear. On the other hand, the column “quantity of edge enhancement” includes all the values for the quantity of edge enhancement (from EMmin to EMmax) corresponding to all the values for pixel state coefficient X. The pair of pixel state coefficient Xi and the quantity of edge enhancement EMi has a unique address (Index=i), where i=1, 2, . . . , n. The setting unit 102 sets the quantity of edge enhancement for each block by deriving the quantity of edge enhancement EMi corresponding to pixel state coefficient Xi given by the controller 9 from the edge enhancement table.

The setting unit 102 determines the final quantity of edge enhancement for each block using the quantity of edge enhancement derived from the edge enhancement table and the block noise information sent from the noise detection unit 101 (the block noise detection unit 146). How to determine the final quantity of edge enhancement will be described with reference to FIG. 15.

The setting unit 102 related to this embodiment is equipped with a memory that is not shown in the figure to temporarily store the block noise information sent from the noise detection unit 101 (the block noise detection unit 146) and the quantity of edge enhancement derived from the edge enhancement table. This memory is equipped with a first memory area to store block noise information as shown in FIG. 15a and a second memory area to store the quantity of edge enhancement as shown in FIG. 15b. The first memory area and the second memory area have n addresses (Index=1−n) corresponding all blocks for one screen (one frame) of image respectively. For example, the address for the block on the upper-left corner of the image of one frame can be given “Index=1”, and the address for the block on the bottom-right corner of the image of one frame can be given “Index=n”.

When the block noise information sent from the noise detection unit 101 (block noise detection unit 146) is input to the setting unit 102, the block noise information is stored in the address for the block corresponding to the noise information in the first memory area. On the other hand, the quantity of edge enhancement derived from the edge enhancement table is stored in the address for the block corresponding to the quantity of edge enhancement in the second memory area.

Here if the block noise information stored in an address of the first memory area shows “There is block noise”, “0” is stored in the corresponding address of the second memory area. For example, as shown in FIG. 15a, if the information “There is block noise” is stored in the address “Index=1” of the first memory area as block noise information, the content of the corresponding address “Index=1” in FIG. 15b of the second memory area is set “0”. In this way it is set that edge enhancement is not performed on the blocks with block noise.

On the other hand, if the block noise information stored in an address of the first memory area shows “There is no block noise”, the quantity of edge enhancement derived from the edge enhancement table is stored in the corresponding address of the second memory area. For example, as shown in FIG. 15a, if the information “There is no block noise” is stored in the address “Index=2” of the first memory area as block noise information, the content of the corresponding address “Index=2” in FIG. 15b of the second memory area is set “EM2” derived from the edge enhancement table. In this way edge enhancement is performed on the blocks without block noise using the quantity of edge enhancement derived from the table.

In the example, although the content of the addresses in FIG. 15b corresponding to the addresses of blocks with noise in FIG. 15a is set “0”, the predetermined quantity of edge enhancement larger than 0 can be written in the addresses in FIG. 15b. However, in this case, the predetermined quantity of edge enhancement shall be small than the average quantity of edge enhancement for the cases of “There is no noise”.

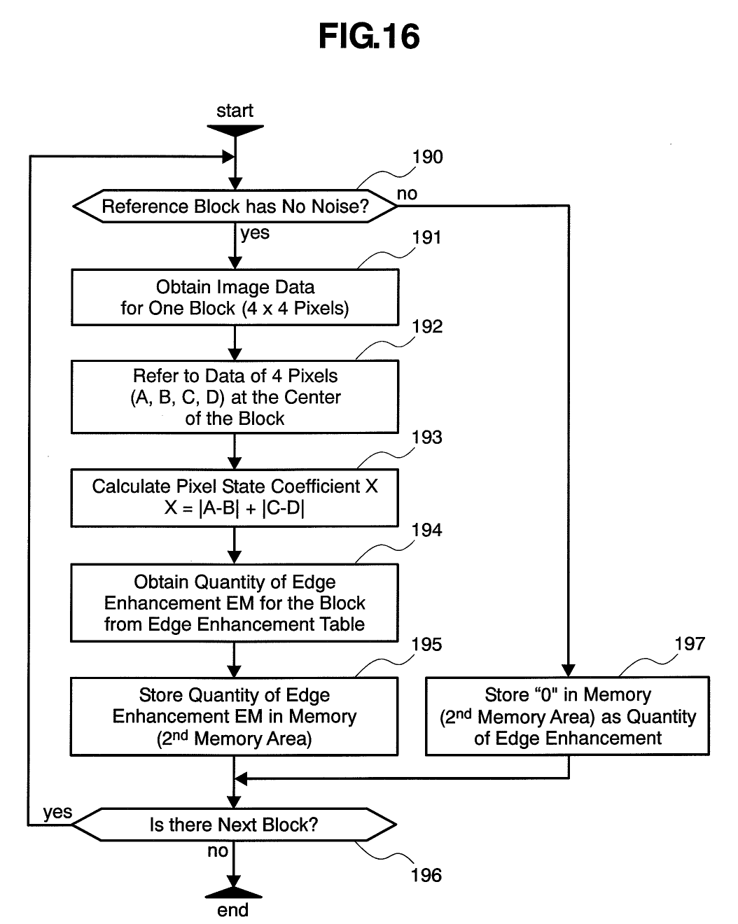

FIG. 16 is shows the flow of the above-described processes to determine the quantity of edge enhancement at the setting unit 102 and the controller 9. The flowchart of FIG. 16 shows details of Step 132 of previously described FIG. 3.

Here the description will be made under the assumption that each block of an input image consists of 4×4 pixels. Firstly, at Step 190, the judgment whether a reference block has block noise or not is made with reference to block noise information sent from the noise detection unit 101. As a result, if the block has block noise, the flow proceeds to Step 197, where “0” is stored in the memory (in the second memory area) as the quantity of edge enhancement, and then the flow proceeds to Step 196. At the same time, information that the block has block noise is stored in the first memory area.

On the other hand, if the judgment that the block has no block noise is made, the flow proceeds to Step 191, where the controller 9 obtains the image data (4×4 pixels) of the reference block. At the same time, information that the block has no block noise is stored in the first memory area. Then after referring to the pixel values of four pixels located at the center of the block at Step 192, the controller 9 calculates pixel state coefficient X and sends the calculation result to the setting unit 102 at Step 193. Next, at Step 194, the setting unit 102 obtains the quantity of edge enhancement EM corresponding to the block from the table based on the pixel state coefficient X. Then, at Step 195, the obtained quantity of edge enhancement EM is stored in the corresponding address of the block in the second memory area. The flow proceeds Step 196 afterward. At Step 196, the judgment whether there is the next block to be referred to or not is made and if there is not the next block to be referred to, these successive processes stop. If there is the next block to be referred to, the flow return to Step 190 and these successive processes are repeated until there is no block to be referred to (,that is, until decoding of all the blocks ends).

The quantities of edge enhancement EM (or “0”) obtained in this way are sent to the image quality correction unit 103. Then the image quality correction unit 103 performs edge enhancement on each block using the corresponding quantity of edge enhancement EM (or “0”).

As described above, this embodiment determines the quantity of image quality correction for each block using block noise information and image information related to the block. Therefore, this embodiment can perform more accurate image quality correction. In the embodiment of the present invention, although edge enhancement processing has been used as an example of image quality correction to describe the present invention, image quality correction is not limited to edge enhancement processing. For example, noise reduction processing can also be applied to this embodiment as an example of image quality correction. In the case of noise reduction processing, as contrasted with edge enhancement processing, noise reduction processing is performed when there is block noise and noise reduction processing is not performed or reduction processing is performed with a small quantity of noise reduction when there is no block noise. In this case, it will be understood that noise reduction processing can be also performed with reference to image information related to a block. For example, even if there is block noise, noise reduction processing can be performed with a smaller quantity of noise reduction when there are a large number of high frequency components in the block and with a larger quantity of noise reduction when there are a small number of high frequency components in the block.

### Second Embodiment

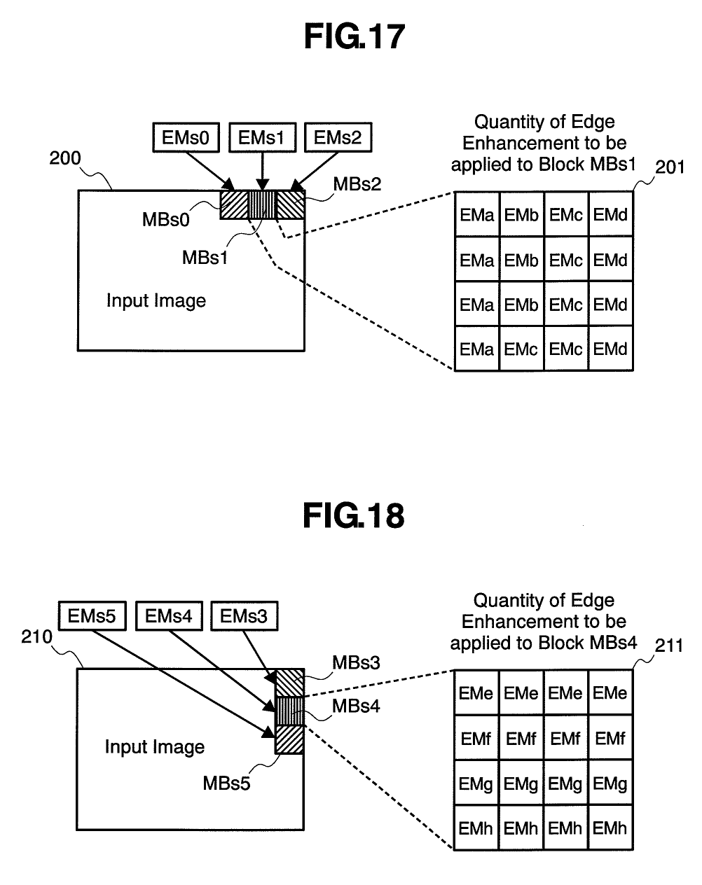

Next, a second embodiment of the present invention will be described below. In the first embodiment of the present invention, the set quantities of edge enhancement have been applied to all pixels in a block. As contrasted with the first embodiment, the second embodiment of the present invention changes a quantity of edge enhancement for a pixel according to the location of the pixel in the block. More specifically, the quantity of edge enhancement to be given to each pixel is set with reference to the quantities of blocks lying adjacent to the block. This method will be described in detail with reference to FIG. 17 and FIG. 18.

FIG. 17 shows an example of how to set the quantity of edge enhancement for a block with reference to the quantities of edge enhancement for blocks lying adjacent to the block horizontally. In this embodiment, the quantity of edge enhancement for each pixel in block MBs1 of a input image 200 is modified using the quantity of edge enhancement EMs1 for block MBs1, the quantity of edge enhancement EMs0 for block MBs0 and the quantity of edge enhancement EMs2 for block MBs2, where block MBs0 and Mbs2 are lying adjacent to block MBs1. Here the quantities of edge enhancement EMa, EMb, EMc and EMd applied to four pixels laid out horizontally are as follows:

EMa=(1/4×EMs0)+(3/4×EMs1) (Eq. 3)

EMb=EMs1 (Eq. 4)

EMc=EMs1 (Eq. 5)

EMd=(1/4×EMs2)+(3/4×EMs1) (Eq. 6)

A symbol 201 in FIG. 17 shows the quantities of image symbol (edge enhancement) calculated in this way. More specifically, in the block MBs1, the quantity of edge enhancement EMa is applied to pixels in the leftmost column, the quantity of edge enhancement EMb is applied to pixels in the second column from the left, the quantity of edge enhancement EMc is applied to pixels in the third column from the left, and the quantity of edge enhancement EMd is applied to pixels in the rightmost column.

FIG. 18 shows an example of how to set the quantity of edge enhancement for a block with reference to the quantities of edge enhancement for blocks lying adjacent to the block vertically. More specifically, in this embodiment, the quantity of edge enhancement for each pixel in block MBs4 of a input image 210 is modified using the quantity of edge enhancement EMs4 for block MBs4, and the quantity of edge enhancement EMs3 for block MBs3 and the quantity of edge enhancement EMs5 for block MBs5, where block MBs3 and Mbs5 are lying adjacent to block MBs4. Here the quantities of edge enhancement EMe, EMf, EMg and EMh applied to four pixels laid out vertically are as follows:

EMe=(1/4×EMs3)+(3/4×EMs4) (eq. 7)

EMf=EMs4 (Eq. 8)

EMg=EMs4 (Eq. 9)

EMh=(1/4×EMs5)+(3/4×EMs4) (Eq. 10)

A symbol 211 in FIG. 18 shows the quantities of edge enhancement calculated in this way. More specifically, in the block MBs4, the quantity of edge enhancement EMe is applied to pixels in the uppermost row, the quantity of edge enhancement EMf is applied to pixels in the second row from the top, the quantity of edge enhancement EMg is applied to pixels in the third row from the top, and the quantity of edge enhancement EMh is applied to pixels in the fourth row from the top.

This embodiment enables finer image quality correction because the quantity of edge enhancement can be set for each pixel in a block, not for the whole block.

The image processor 100 can determine the quantity of image quality correction based on encoding information and category information of a program, not based on encoding information and image information of blocks. In other words, it means that the quantity of image quality correction that has been determined based on encoding information, for example, in the first embodiment of the present invention can be modified based on category information of a program. For example, in the case that image quality correction is edge enhancement, if the program is a sport program, the quantity of edge enhancement can be set larger than the quantity determined based on encoding information, and if the program is a news program, the quantity of edge enhancement can be set smaller than the quantity determined based on encoding information.

The present invention can be applied, for example, to a note PC or a desktop PC that is equipped with a receiving & reproducing function of a digital broadcasting such as 1-seg broadcasting, an apparatus that is equipped with an image reproducing function such as a digital TV set, a car navigation system, a potable DVD player or the like.

What is claimed is:

1. A digital broadcasting receiving apparatus, comprising:
a tuner which receives digital broadcasting signals;
a decoder which decodes digital broadcasting signals received by the tuner and outputs the image signals; and
an image processing unit which performs image processing on the image signals output from the decoder,
wherein the image processing unit is configured to be able to perform image correction on the image signals for each pixel block based on encoding information included in the digital broadcasting signals and image information obtained from the image signals.

2. A digital broadcasting receiving apparatus according to claim 1, wherein the digital broadcasting signals are 1 segment broadcasting signals.

3. A digital broadcasting receiving apparatus according to claim 1, wherein the encoding information includes at least one of bit rate information, quantization step information, DCT coefficient information, and motion vector information that are related to the digital broadcasting signals.

4. A digital broadcasting receiving apparatus according to claim 1, further comprising:
a display unit to display image signals on which image quality correction is performed at the image processing unit.

5. A digital broadcasting receiving apparatus comprising:
a tuner which receives digital broadcasting signals;
a decoder which decodes digital broadcasting signals received by the tuner and outputs the image signals; and
an image processing unit which performs image processing on the image signals output from the decoder,
wherein the image processing unit includes:
a noise detection unit which detects noise information for each pixel block based on encoding information of an image included in the digital broadcasting signals;
a setting unit which sets the quantity of image quality correction based on noise information detected at the noise detection unit and image information for pixel blocks obtained from the image signals; and
an image quality correction unit configured to be able to perform image quality correction on the image signals for the each pixel block according to the quantity of image quality correction set at the setting unit.

6. A digital broadcasting receiving apparatus according to claim 5, wherein
the noise detection unit obtains bit rate information, quantization step information, DCT coefficient information, and motion vector information for each pixel block included in the digital broadcasting signals , as the encoding information, and makes the judgment that the pixel block includes block noise if it is found to meet at least one of the following conditions that:
the bit rate information is equal to or lower than a first threshold;
the quantization step information is equal to or larger than the second threshold;
the DCT coefficient information is equal to or larger than a third threshold; and
the motion vector information is equal to or larger than a fourth threshold.

7. A digital broadcasting receiving apparatus according to claim 6, wherein
image quality correction performed by the image quality correction unit is edge enhancement processing; and
the edge enhancement processing is performed on pixel blocks which are judged to have no block noise at the noise detection unit.

8. A digital broadcasting receiving apparatus according to claim 6, wherein
image quality correction performed by the image quality correction unit is edge enhancement processing; and
the edge enhancement processing is performed on the pixel blocks which are judged to have no block noise with larger quantities of edge enhancement than the quantities of edge enhancement for blocks which are judged to have block noise.

9. A digital broadcasting receiving apparatus according to claim 6, wherein
image quality correction performed by the image quality correction unit is noise canceling processing; and
the noise canceling processing is performed on pixel blocks which are judged to have block noise at the noise detection unit.

10. A digital broadcasting receiving apparatus according to claim 6, wherein
image quality correction performed by the image quality correction unit is noise canceling processing; and
the noise canceling processing is performed on the pixel blocks which are judged to have block noise with larger quantities of edge enhancement than the quantities of edge enhancement for blocks which are judged to have no block noise.

11. A digital broadcasting receiving apparatus according to claim 6, wherein the first threshold, the second threshold, the third threshold, and the fourth threshold can be changed according to categories of received digital broadcasting programs.

12. A digital broadcasting receiving apparatus according to claim 5, wherein the setting unit uses differences among the luminance component valus of neighboring pixels in the pixel block as image information related to the pixel block.

13. A digital broadcasting receiving apparatus according to claim 10, wherein the differences among the luminance component valus of neighboring pixels are derived from a plurality of pixels other than outer circumferential pixels in the pixel block.

14. A digital broadcasting receiving apparatus according to claim 5, wherein the setting unit sets the quantity of image quality correction for a pixel block using the quantity of image quality correction for the pixel block and the quantities of image quality correction for pixel blocks lying adjacent to the block vertically and horizontally.

15. A digital broadcasting receiving apparatus according to claim 5, wherein the setting unit includes a judgment unit which makes the judgment whether there are high frequency components in at least two pixels other than outer circumferential pixels of the pixel block as a piece of image information of the pixel block.

16. A digital broadcasting receiving apparatus according to claim 5, wherein
the setting unit:
includes an image quality correction table;
retrieves corresponding quantity of image quality correction from the table according to the judgment result made by the judgment unit; and
sets the quantity of image quality correction as the quantity of image quality correction for the pixel block.

17. A digital broadcasting receiving apparatus according to claim 5, wherein
the noise detection unit includes at least one of the following judgment units:
a bit rate judgment unit which makes the judgment that there is block noise when the bit rate information of the digital broadcasting signals is equal to or lower than the first threshold;
a quantization judgment unit which makes the judgment that there is block noise when the quantization step is equal to or larger than the second threshold;
a DCT coefficient judgment unit which makes the judgment that there is block noise when the number of zeroes in the predetermined two-dimensional DCT coefficients corresponding to AC components is equal to or larger than the third threshold; and
a motion vector judgment unit which makes the judgment that there is block noise when the motion vector is equal to or larger than the fourth threshold.

18. A digital broadcasting receiving apparatus according to claim 5, including the noise detection unit which comprises:
a bit rate judgment unit which makes the judgment that there is block noise when the bit rate information of the digital broadcasting signals is equal to or lower than the first threshold;
a quantization judgment unit which makes the judgment that there is block noise when the quantization step is equal to or larger than the second threshold;
a DCT coefficient judgment unit which makes the judgment that there is block noise when the number of zeroes in the predetermined two-dimensional DCT coefficients corresponding to AC components is equal to or larger than the third threshold; and
a motion vector judgment unit which makes the judgment that there is block noise when the motion vector is equal to or larger than the fourth threshold,
wherein the noise detection unit makes the judgment that the pixel block has block noise if at least one of the bit rate judgment unit, the quantization unit, the DCT coefficient unit, and the motion vector unit makes the judgment that there is block noise, and the setting unit sets the quantity of image quality correction according to the judgment result and sends the quantity of image quality correction to the image quality correction unit.

19. A digital broadcasting receiving apparatus comprising:
a tuner which receives digital broadcasting signals;
a decoder which decodes the digital broadcasting signals received by the tuner and outputs the decoded image signals; and
an image processing unit which performs image correction on the image signals output by the decoder,
wherein the image processing unit sets the quantity of image quality correction according to encoding information of an image included in the digital broadcasting signals and categories of received digital broadcasting programs and performs image quality correction with the quality of image quality correction.
